(19) United States
(12) Patent Application Publication
(10) Pub. No.: US 2001/0056381 A1
(43) Pub. Date: Dec. 27, 2001

(54) Cooperative medical shopping system

(76) Inventor: David A. Boeke, Loveland, OH (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/878,806

(22) Filed: Jun. 11, 2001

Related U.S. Application Data
(60) Provisional application No. 60/211,809, filed on Jun. 14, 2000.

(51) Int. Cl. G06F 17/60

(52) U.S. Cl. 705/26

(57) ABSTRACT

The present invention provides for a system and method for supplying medical products over the Internet. The system facilitates the selection and ordering of medical products by the medical staff while providing a mechanism whereby an administrator or purchasing agent can control the final purchase decision. Medical staff can create custom orders that may be shared in within an organization or reused. Such sharing of orders allows medical staff to create complex customized orders that can be grouped by medical procedure or the like.

### CROSS REFERENCE TO RELATED APPLICATION

This application claims the benefit under 35 U.S.C. §119(e) of earlier-filed provisional application, serial No. 60/211,809, filed on Jun. 14, 2000, which is incorporated by reference herein in its entirety.

### TECHNICAL FIELD

The present invention relates generally to systems and methods for on-line purchasing and more particularly to a system for permitting medical personnel and purchasing agents to cooperatively purchase medical supplies.

### BACKGROUND OF THE INVENTION

Given the ubiquity of the Internet and the World Wide Web (the Web), businesses have been seeking to leverage the Web for more efficient delivery of goods and services. Thus far, particularly in the business-to-consumer space, the Web has been brought to bear to provide on-line purchases of consumer merchandise, delivery of audio and video content, and so on. In the business-to-business space, many businesses are using the Web for applications from an on-line purchasing system to a just-in-time inventory system.

Typically, the on-line purchasing systems employed on the Web implement a virtual shopping cart wherein a user purchasing goods adds selected items to the shopping cart. At a point of purchase, the user proceeds to check-out and purchases the selected items previously placed in the virtual shopping cart. Such virtual shopping cart systems typically emulate a brick-and-mortar shopping experience by providing a virtual shopping cart into which a user impulsively places goods displayed on the merchant's web site.

Simply emulating a brick-and-mortar shopping experience does not take full advantage of the flexibility offered by the Web. The Web makes it possible to tailor the experience to a particular user based on account information, demographic information, and other information available to the on-line shopping system.

The medical community has some unique supply acquisition procedures that accommodate particular doctor supply preferences, cost controls, insurance billing, and so on. For example, one doctor may prefer one type of instrument to perform a particular procedure while another doctor may prefer a different type of instrument to perform the same or a similar procedure. However, one the one hand, hospitals desiring to ensure proper billing, and to control inventory and costs may find it undesirable to have doctors making purchases directly. On the other hand, it would be desirable to allow doctors to specify particular purchases.

The invention addresses the need for an on-line shopping system directed to the purchasers of medical supplies that allows medical personnel and administrators, purchasing agents, and so on to participate in the purchase of medical supplies on-line.

### SUMMARY OF THE INVENTION

The present invention provides for a system and method for supplying medical products over the Internet. The system facilitates the selection and ordering of medical products by the medical staff while providing a mechanism whereby an administrator or purchasing agent can control the final purchase decision. Medical staff can create custom orders that may be shared in within an organization or reused. Such sharing of orders allows medical staff to create complex customized orders that can be grouped by medical procedure or the like.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings exemplary constructions of the invention; however, the invention should not be limited to the specific methods and instrumentalities disclosed. In the drawings:

FIG. 1 is schematic diagram representing a network computer model in which aspects of the present invention may be incorporated;

FIG. 2 is a block diagram that illustrates the operation of the invention in an environment such as that depicted in FIG. 1;

FIG. 3 is an example of a web page generated after login in accordance with aspects of the invention;

FIG. 4 is an example of a web page generated after entering the product catalogue in accordance with aspects of the invention;

FIG. 5 is an example of a web page generated after entering the product catalogue and illustrates the tailoring of the shopping experience of the invention;

FIG. 6 is an example of a web page generated to show related or substitute products in accordance with aspects of the invention;

FIG. 7 is an example of a web page generated in accordance with aspects of the invention that illustrates the current order functionality;

FIG. 8 is an example of a web page generated for order management in accordance with aspects of the invention;

FIG. 9 is an example of a first portion of web page generated to check order status in accordance with aspects of the invention;

FIG. 10 is an example of a first portion of web page generated to check order status in accordance with aspects of the invention; and

FIG. 11 is an example of a web page generated to present order details from the order status page in accordance with aspects of the invention.

### DETAILED DESCRIPTION OF THE INVENTION

### OVERVIEW

The invention provides an environment to supply medical supplies by way of the Internet. In general, medical organizations have a need to provide medical staff with the ability to order product and supplies in accordance with their own professional judgement and expertise. However, in order to facilitate billing, inventory control, and so on, medical organizations typically need to have an administrator or purchasing agent control the actual approval of purchases. The invention provides a mechanism whereby medical staff can create custom orders that can be reused and shared with other medical staff in the purchase of medical supplies while facilitating purchase approval by an administrator.

### Exemplary Operating Enveronment

The following discussion is intended to provide a brief general description of a suitable environment in which the invention may be implemented. The system generally operates over a communications network, which may comprise a LAN, a WAN, an intranet, the Internet, or any combination of such networks. Although it is not a requirement that the invention operate in a particular environment, the invention will be described in the general context of Web standards, such as HTML, hyperlinking, etc.

In general terms, the Internet is a collection of interconnected public and private networks. The interconnected networks communicate with each other by way of predefined communications protocols, primarily TCP/IP and HTTP. Intranets are private networks that follow Internet communication protocol standards and may even connect to and communicate with the intranet. The interconnected networks all coupled together form a network of global scale.

A number of server computers are connected to the Internet communications network. The server computers serve information, primarily in the form of HTML or HTML-like pages to client computers. Client computers are capable of selectively connecting to various ones of the server computers to exchange information. Typically, the client computers communicate with a browser that receives the HTML files from a selected server. The server and client computers may also have program modules that include routines, programs, objects, components, data structures and the like that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

### Network Environment

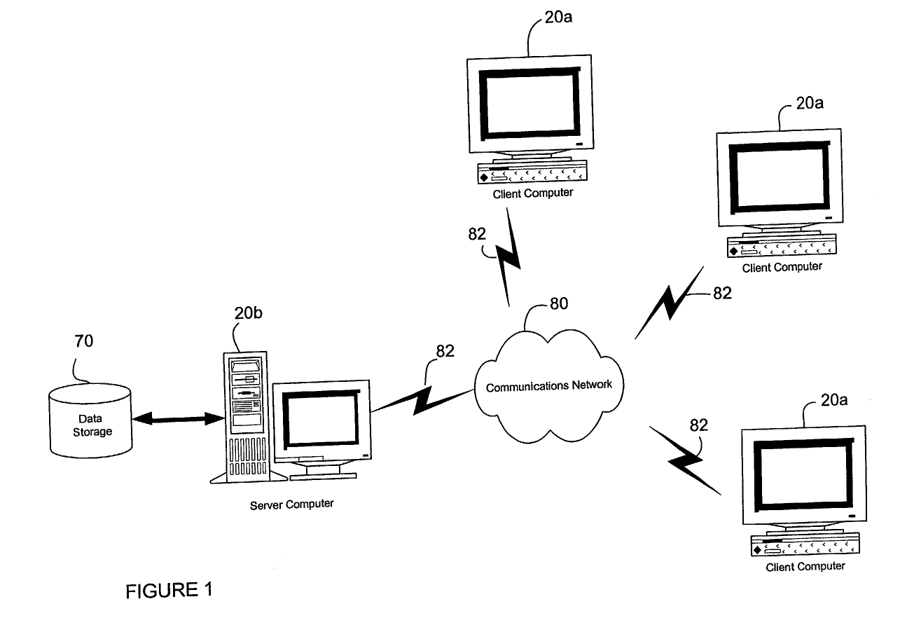

FIG. 1 illustrates an example environment in which the present invention may be employed. Of course, actual environments can be arranged in a variety of configurations; however, the environment is shown here provides an illustrative framework for further understanding the type of environment in which the present invention operates. The system may include client computers 20a and a server (or servers) computer 20b. Data storage 70 is coupled to and controlled by server computer 20b. The client and server computers 20a, 20b communicate with each other by way of communications network 80, which, as described above, may be a LAN, a WAN, an intranet, the Internet, etc.

Client computers 20a and server computer 20b are connected to the communications network by way of communications interfaces 82. Communications interfaces 82 can be any one of the well-known communications interfaces such as Ethernet connections, modem connections, DSL connections and so on. Communications interfaces 82 may also be by way of an intermediate communications network such as a LAN, wireless, etc.

Data storage 70 comprises data base systems that contain information vital to the operation of the system of the present invention. Data storage 70 is shown here as a single data storage but may in fact be a number of separate data bases each maintaining information of interest to the system. As users make requests to server computer 20b, server computer 20b fulfills the request in part by selecting data from data storage 70.

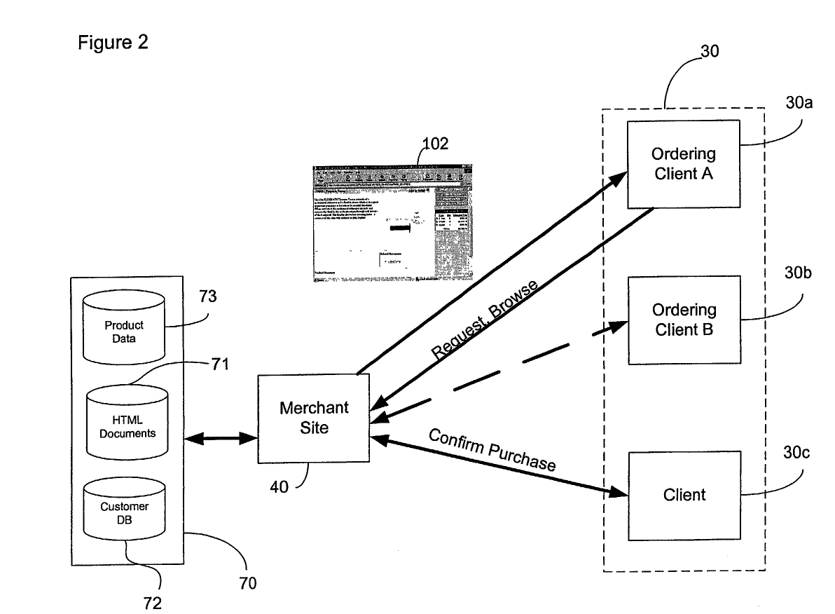

FIG. 2 illustrates the operation of the system of the present invention in the environment described in connection with FIG. 1. Merchant site 40 maintains access to HTML documents 71, a customer database 72, and a product database 73. The merchant site can be accessed by clients (e.g., client set 30) desiring to purchase supplies. Each client set may comprise multiple clients each having a common business connection. For example, a client set may comprise a set of doctors affiliated with a particular hospital as well as a hospital administrator or purchasing agent.

Some of the clients may desire to make purchases of equipment from the merchant site as indicated by the client 30a. Accordingly, client 30a logs in to merchant site 40 and is identified as affiliated with client 30. Thereafter, relevant customer information is retrieved from customer database 72 to tailor the shopping experience as described more fully below. As client 30a makes requests or browses merchant site 40, merchant site 40 assembles request information by combining information from customer database 72, product database 73, and HTML documents store 71 to produce HTML pages (e.g., page 102) that are returned to client 30a for display. Client 30a may then select supplies for purchase.

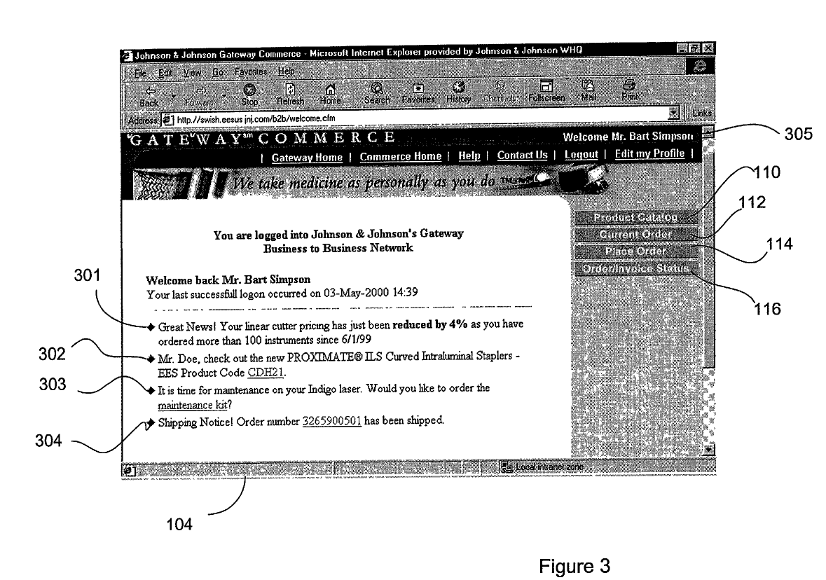

In accordance with an aspect of the invention, client 30c (e.g., a purchasing agent), approves the purchase at a later time. Sometime thereafter merchant site 40 will deliver the supplies ordered by clients 30a, 30b, etc. that are confirmed for purchase by client 30c. FIGS. 3-11, described below, further illustrate the interaction of the clients, e.g., 30 and the merchant site 40. In the interest of clarity, the Figures are described in the context of the transactions of FIG. 2.

### Shopping System

FIG. 3 provides an example of a login HTML page display 104 that illustrates aspects of the login procedure of the invention. After logging in, client 30a has been identified as client Bart Simpson 305. Notably, the login page illustrates that the merchant site tracks the customer as a member of both the individual client 30a and a member of client set 30. For example, as indicated by bullet 301, because clients in client set 30 have ordered more than a given number of a particular item, the cost to all client in client set 30 have been reduced. Moreover, by tracking the ordering patterns of client 30a, merchant system 40 can determine that client 30a may need to order additional items as indicated by bullets 302 and 304. Moreover, merchant system 40 can confirm that an order placed by client 30a had been subsequently confirmed and shipped as indicated by bullet 304.

From the login main page, by way of buttons 110, 112, 114, and 116 client 30a has an option of browsing the product catalog, reviewing current orders, placing orders, and checking the status of orders.

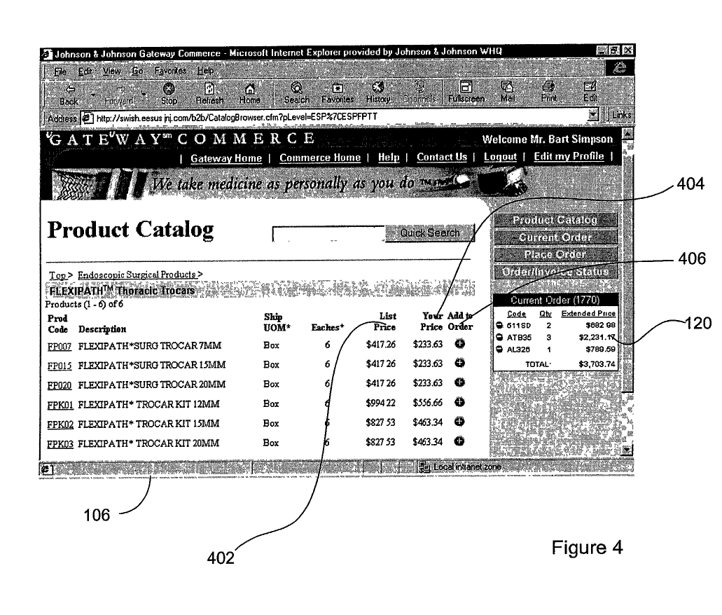

FIG. 4 illustrates the interaction of client and merchant site 40 when client 30 has selected the product button 110. Here, client 30a has entered the product catalogue and selected Endoscopic Surgical Products. Accordingly, merchant site 40 provides a list of products falling into the selected category that are displayed by way of web page 106. Notably, merchant site 40 has provided the list prices 402 for the product as well as the contract price 404 that are determined based on client 30a being a member of client set 30. Additionally, client 30a is provided with a column of add to order buttons 406 whereby client 30a can select items to be placed into the current order shopping cart 120. Notably, current-order shopping cart 120 remains persistent on the product catalogue page. Accordingly, client 30a can determine the contents of the shopping cart while shopping without the need to change to a separate page to review the shopping cart contents.

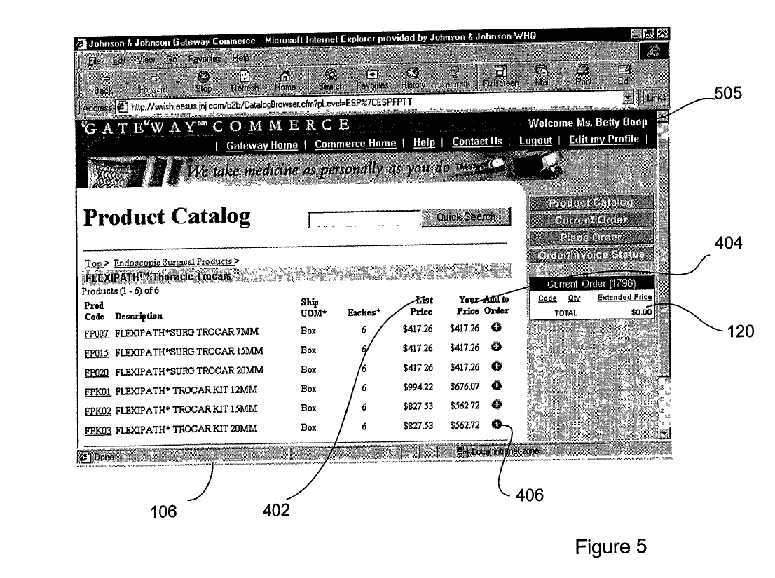

FIG. 5 illustrates how the contract price 404 changes for a customer that are members of different client sets. Here, web page 106 is displayed for client Betty Boop 505. Notice that although the list price 402 numbers are the same as the numbers for Bart Simpson in FIG. 4, the your price 404 has changed. This may be caused by a number of pricing factors such as order volume.

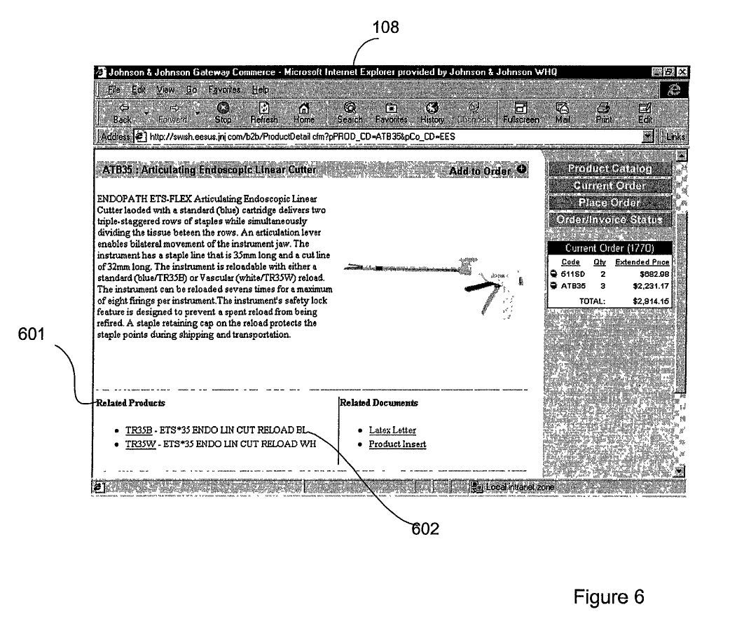

FIG. 6 illustrates how merchant site 40 can enhance the shopping experience for purchasers of medical supplies by suggesting alternative and related products. When a particular product is selected such as the Articulating Endoscopic Linear Cutter shown in web page 108, merchant site 40 can display related products 601 to the ordered product. For example, related products 601 may comprise refills 602. Additionally, if a particular product is out of stock, related products 601 may display an alternative product that can be substituted in a particular medical procedure.

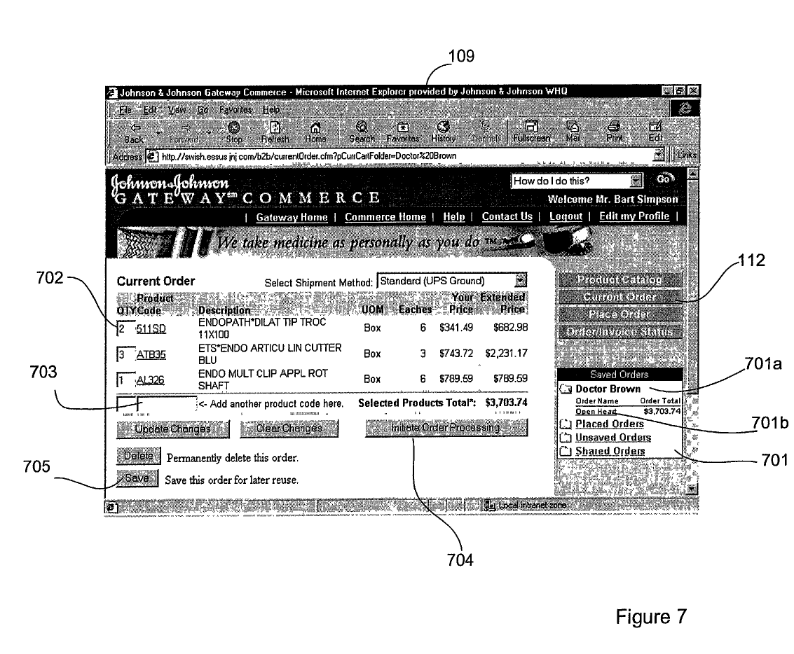

After client 30a has completed a shopping event, the order is saved for later use by client 30a and other clients in the client set, such as purchasing client 30c. FIG. 7 illustrates the operation of saving the order. Initially, client 30a enters the current order page by selecting current order button 112, which is available from other pages on merchant site 40. Page 109 is generated by merchant site 40 and displayed by client 30a. Current order page 109 displays the products in the shopping cart in detail. Client 30a can then increase the quantity of particular products 702, add additional products directly by entering a product code number in box 703, delete the order, save the order, etc. By depressing the “Initiate Order Processing” button 704 the order is started. By depressing the Save button 705, the order can be saved in a saved orders folder for later reuse by the same or other clients 30a.

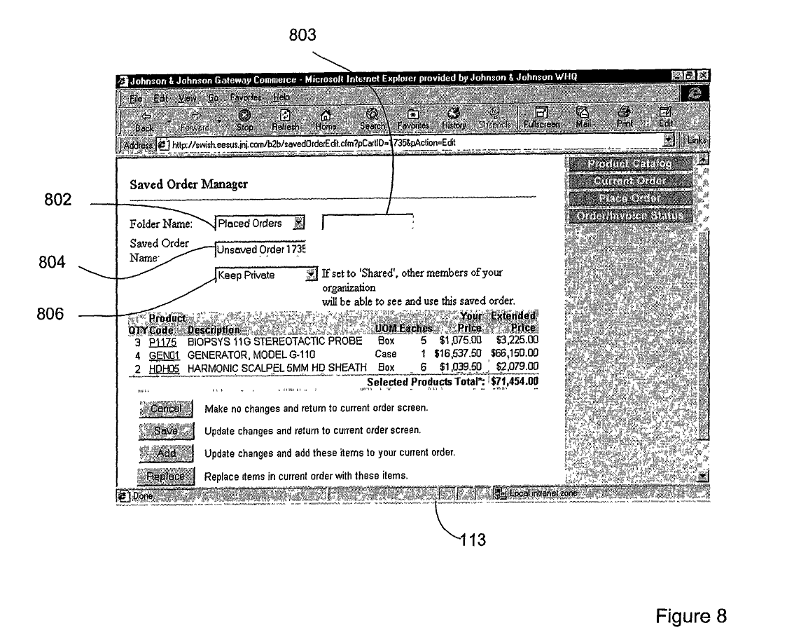

FIG. 8 illustrates the operation of the system after depressing the Save button 705. The Saved Order Manager is invoked bringing up the saved order manager page 113. Here, client 30a can select the name of the folder in which to save the order. The folder is selected from previously created folders 802. Alternatively, a new folder can be created by entering the name of the folder in field 803. Additionally, the order is given a name by entering the order name in field 804. Notably, the order can be kept private or shared by selecting from drop down box 806. If shared, then other clients in client set 30 can access the order. The save order and sharing function may be useful for building orders for particular medical procedures. For example, a particular doctor may have a set of supplies that he or she uses to perform an open-heart surgery. By saving the order, the doctor can quickly retrieve the order each time the operation is performed without the need to re-enter or even remember the supplies that are necessary for the operation. Moreover, as the procedure is refined, the saved order can be easily updated. Additionally, sharing the order may be useful for doctors to share their customized procedures with colleagues. For example, FIG. 7 shows in the saved order box 701 a folder for Doctor Brown 701a. In that folder, Doctor Brown has placed an order Open Heart 701b. If the order is set to shared by the save order manager, illustrated in FIG. 8, then other doctors and medical professionals can use the same order when order supplies for the same operation.

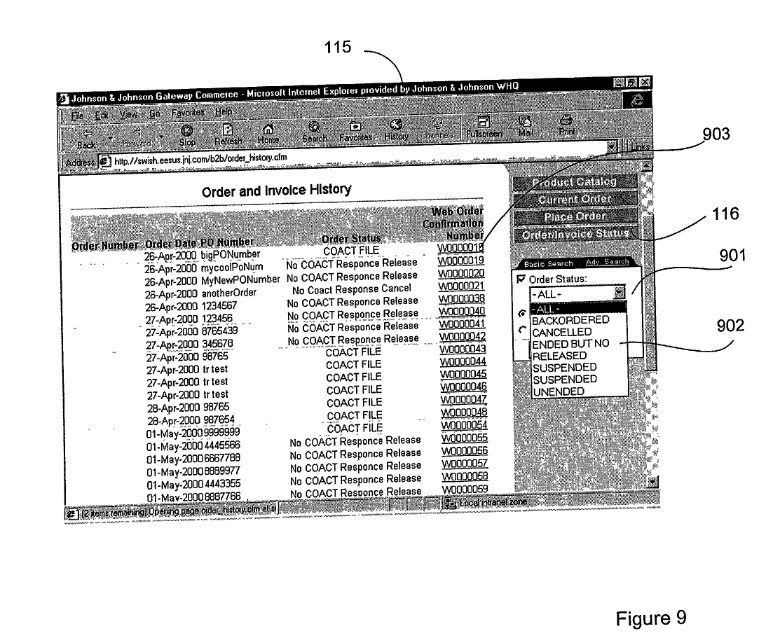

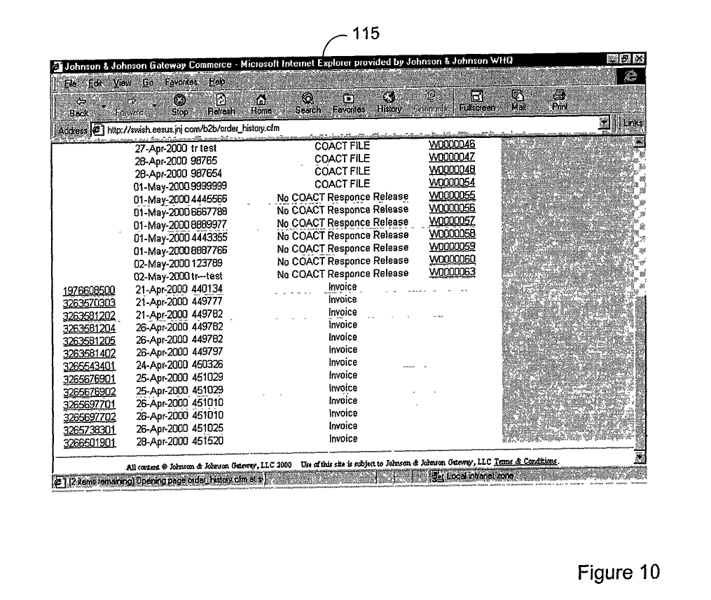

FIGS. 9-11 illustrate the operation of the order/invoice history. The order invoice history is invoked by depressing button 116. Thereafter, the Order and Invoice History page 115 is displayed on client 30a. FIGS. 9 and 10 illustrate the top and bottom portions, respectively, of an exemplary page display. Notably, the display includes all relevant orders for client 30a regardless of origin. For example, orders that are made by way of telephone, or by way of a facsimile, or by way of the Internet are all listed on the order and invoice history page 115. Additionally, the order status can be searched by way of search box 901. By checking order status and dropping down and selecting from drop down box 902, orders can be selectively searched. For example, selecting “BACKORDERED” from drop down box 902 will cause only backordered orders to be display and so on. Selecting a particular order, e.g., order 903 will bring up the details of the order as described below.

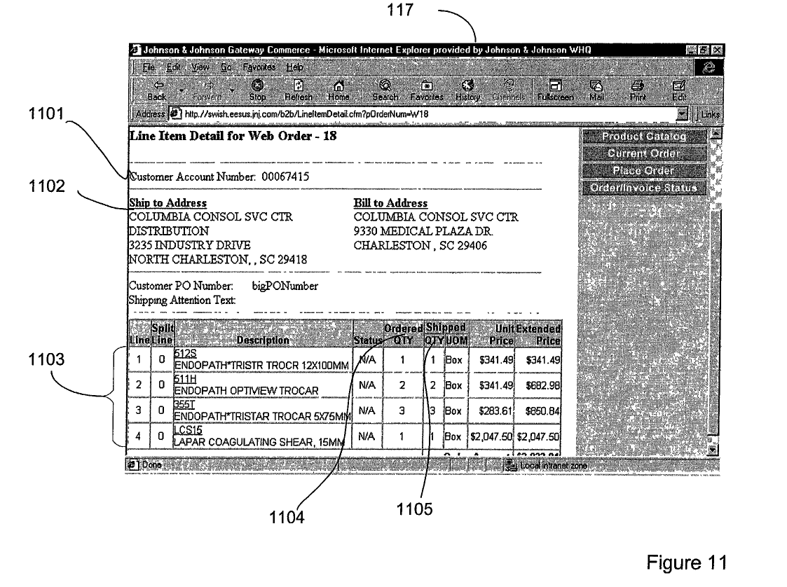

FIG. 11 illustrates a typical web order detail page. The page provides the customer account number 1101, the ship to and bill to address information 1102, and a list 1103 of products in the order. The list 1103 displays the quantity of a particular product that was ordered 1104 and the portion of that quantity that was shipped 1105.

What is claimed is:

1. A method for wearing medical products over the Internet, comprising the act of:
providing a server computer with a medical products catalog;
accepting on said server a request to create at least one custom order from the first user;
maintaining in said at least one custom order a subset of medical products ordered by said first user wherein said first user has indicated that said products be maintained in said custom order;
accepting on said server a second request for said at least one custom order from the second user; and
allowing said second user to request and order substantially the same as set at least one custom order.
